(19) United States
(12) Patent Application Publication
(10) Pub. No.: US 2007/0082976 A1
(43) Pub. Date: Apr. 12, 2007

(54) Hydrophobic, water-insoluble polyurethane thickeners in granule or powder form and their use for thickening aqueous systems

(75) Inventors: Sandra Bauer, Midlothian, VA (US); Gunther Link, Wernigerode (DE)

Correspondence Address: Leopold Presser, Scully, Scott, Murphy & Presser, 400 Garden City Plaza, Garden City, NY, 11530, US

(73) Assignee: Goldschmidt GmbH, Essen (DE)

(21) Appl. No.: 11/545,680

(22) Filed: Oct. 10, 2006

(30) Foreign Application Priority Data
Oct. 12, 2005 (DE) 10 2005 048 866.8

(51) Int. Cl. C09D 11/00; C08G 18/08

(52) U.S. Cl. 523/160; 524/589

(57) ABSTRACT

The invention provides pulverulent, emulsifier-free, hydrophobic, polyurethane-based thickener preparations which lend themselves particularly well to incorporation into water-based inks, paints, and varnishes, and to their use as rheological additives for thickening preferably aqueous systems, comprising a) at least one water-soluble active polyurethane thickener substance; and b) at least one water-insoluble or sparingly water-soluble active polyurethane thickener substance.

### FIELD OF THE INVENTION

The invention relates to innovative, pulverulent, emulsifier-free, hydrophobic, polyurethane-based thickener preparations which lend themselves particularly well to incorporation into water-based inks, paints, and varnishes, and to their use as rheological additives for thickening preferably aqueous systems.

### BACKGROUND OF THE INVENTION

A great number of polyurethane-based associative thickeners for aqueous systems are known and have been described. U.S. Pat. No. 4,499,892 describes, for example, the preparation and the use of active polyurethane thickener substances for aqueous formulations. The following further patents may be mentioned here by way of example: DE-A-14 11 243, DE-A-36 30 319, DE-A-196 44 933, EP-A-0 031 777, EP-A-0 307 775, EP-A-0 495 373, U.S. Pat. No. 4,079,028, U.S. Pat. No. 4,499,233, U.S. Pat. No. 4,155,892 or U.S. Pat. No. 5,023,309.

DE-A-101 11 791 describes the structure of polyurethane-based thickeners in general form. Accordingly, such polyurethane thickeners possess urethane groups and, at the same time, hydrophilic segments in an amount of at least 50% by weight and hydrophobic segments in an amount of not more than 10% by weight. Hydrophilic segments in this context are, in particular, high molecular weight polyether chains, that are typically composed of ethylene oxide polymers. Hydrophobic segments are, in particular, hydrocarbon chains having at least six carbon atoms. The specific molecular structure, the balance between hydrophilic and hydrophobic segments, and the molecular weight determine the final rheological behavior in the application medium.

Polyurethane thickeners of the type specified, and preparations thereof, are suitable as auxiliaries for adjusting rheological properties of aqueous systems such as automotive finishes and industrial coatings, plasters and paints, printing inks and textile inks, pigment pastes, and pharmaceutical and cosmetic preparations. Polyurethane-based thickeners are suitable in principle for the associative linking of all spherical interfaces, particularly in aqueous emulsion and dispersion systems.

A vital requirement for the use of polyurethane thickeners is an ideal distribution of the associative compounds. Thus, aqueous polyurethane thickener preparations in accordance with the prior art require additional, usually nonionic, emulsifiers (DE-A-196 00 467). EP-A 0 618 243, furthermore, describes the use of acetylenediol derivatives as formulation ingredients. Also known is the use of volatile or nonvolatile organic solvents (DE-A-196 44 933). A common feature of all of these additional formulation ingredients is that they are intended to reduce the product viscosity and facilitate distribution of the active polyurethane substance in the application medium. Consequently, the commercially customary polyurethane thickener formulations possess in general an active substance fraction of 10% to 50%.

Although the known polyurethane thickeners find broad application, they have substantial disadvantages. The majority of commercial products are offered as aqueous preparations with a reduced active substance fraction. In addition to a series of commercial disadvantages such as packaging costs, storage costs, and transport costs, prior-art products of this kind at the same time possess a series of technical disadvantages.

Where polyurethane thickeners are needed for retrospective correction to the viscosity of emulsion paints that have already been produced, the as-supplied form (e.g., 50%) is brought by dilution (generally 1:9) to a concentration of 5%. As compared with the actual active substance, the space required for the storage of such an additive is increased by 20 fold.

Where emulsifiers are added in order to liquefy the product formulation, these surfactants may give rise to foam stabilization during the production of the paints. Furthermore, undesirably, the water resistance and weathering stability of coating systems, and, in the case of architectural paints, their abrasion resistance are lowered.

Where water-soluble or water-miscible organic solvents, such as alcohols or glycol derivatives, for example, are utilized for the purpose of reducing the inherent viscosity of the aqueous polyurethane thickener preparation, one decisively disadvantageous result is the introduction of unwanted solvent, which runs counter to the concept of reducing the environmentally hazardous VOCs.

It is known that the problems outlined occur to an increased extent with structurally viscous, branched polyurethane thickeners. In urethanes which have only a flow-control effect, and which additionally possess a low molecular weight, the problems indicated above do not, of course, occur.

In order to circumvent the nexus of problems indicated above, attempts have already been made a number of times to use pure active polyurethane thickener substances or to provide them with processing-friendly modifications. Pure active polyurethane thickener substances, with a high thickening action, however, are compounds which range from solid to waxlike, having melting points of between 25° to 60° C. Functionally appropriate, water-soluble active substances in particular possess storage problems, since in this case the polymer particles stick to one another even at slightly increased temperatures. Moreover, the dissolution and metering operation, which is to be performed in water, is itself difficult to control. If excessive amounts are introduced too quickly and with too little shearing, there is a risk of caking and of gelling.

EP-A-0 773 263 describes active polyurethane substances which are known per se and are combined with surface-active agents (anionic, cationic, and nonionic agents). The fraction of active urethane substance in this case is 50% to 85%.

DE-A-101 11 791 also utilizes active polyurethane substances that are known per se, and combines them with water-soluble or water-insoluble substances. Removal of the solvent gives solid formulations. The patent examples of DE '791 possess active substance contents of only 11% to 65%.

The properties of existing pulverulent products, composed 100% of active polyurethane thickener substance, are therefore less than ideal. They are frequently difficult to incorporate into varnishes, paints or inks, and, as a result, lead to caking in the surface-coating mixtures. Furthermore, their effect is often inadequate. In addition, the preparation of solid thickeners can be difficult, since their ingredients are usually waxlike at room temperature, and so it is not possible to prepare free-flowing, storable powders.

The examples identified above show that there is a need for new, pulverulent, emulsifier-free polyurethane thickeners.

### SUMMARY OF THE INVENTION

An object on which the present invention is based, accordingly, was to provide new, emulsifier-free and solvent-free polyurethane thickeners. The pulverulent or granulated products should be free-flowing and storable and lend themselves to easy incorporation into aqueous systems, by stirring, in all preparation phases. This applies equally to any subsequent additions to already fully formulated varnishes, paints and/or inks.

The aforementioned object is surprisingly solved by a pulverulent thickener preparation composed of at least one water-soluble active polyurethane thickener substance and at least one water-insoluble or sparingly water-soluble active polyurethane thickener substance.

The invention accordingly provides pulverulent thickener preparations comprising
a) at least one water-soluble active polyurethane thickener substance; and
b) at least one water-insoluble or sparingly water-soluble active polyurethane thickener substance.

The invention further provides all combinations of the water-soluble active polyurethane substances a) with water-insoluble polyurethanes b). Preferred combinations are those with 20% to 90% by weight of b) and, correspondingly, 80% to 10% by weight of a).

### DETAILED DESCRIPTION OF THE INVENTION

The present invention, which provides pulverulent thickener preparations, will now be described in greater detail by referring to the following discussion.

As stated above, the present invention provides pulverulent thickener preparations that include a) at least one water-soluble active polyurethane thickener substance; and b) at least one water-insoluble or sparingly water-soluble active polyurethane thickener substance.

Water-soluble active polyurethane thickener substances a) are known and have been propagated and employed successfully for many years as thickeners, both alone and in the abovementioned formulations, for the known application.

Water-soluble active polyurethane thickener substances a) are characterized by a water solubility of greater than 10 g/l. Particularly preferred examples of water-soluble active polyurethane thickener substances a) are those which have hydrophilic segments for solubility.

Hydrophilic segments here are, in particular, high molecular mass polyether chains, composed in particular of ethylene oxide polymers. Hydrophobic segments are, in particular, hydrocarbon chains having at least six carbon atoms.

Water-insoluble or sparingly water-soluble active polyurethane thickener substances b) are active polyurethane thickener substances having a solubility in water of less than 10 g/l. The solubility in water is preferably less than 5 g/l. Although the polyurethanes defined in accordance with the invention themselves possess virtually no solubility, or only low solubility, the polymer is capable of taking up water to a certain degree; in other words, the products may be water-swellable.

Particularly preferred examples of water-insoluble or sparingly water-soluble active polyurethane thickener substances are those active polyurethane thickener substances wherein
(A) at least trifunctional aliphatic and/or aromatic isocyanate oligomers are reacted by processes that are known per se with
(B) 90.0 to 99.8 eq-% of one or more polyethers of the structure
   RO(SO)_{w}(BO)ₓ(PO)_{y}(EO)_{z}—H and
(C) 0.2 to 10.0 eq-% of at least one of the compounds selected from the group of
   (a) polyethers of the structure
      HO(SO)_{w′}(BO)_{x′}(PO)_{y′}(EO)_{z′}—H;
   (b) polyetherpolydimethylsiloxanediols of the structure
      HO(SO)_{w′}(BO)_{x′}(PO)_{y′}(EO)_{z′}Z-PDMS-Z(EO)_{z′}(PO)_{y′}(BO)_{x′}(SO)_{w′}—H;
   (c) polyesterpolydimethylsiloxanediols of the structure
      H—(OC₅H₁₀CO-)_{y′}-Z-PDMS-Z-(CO—C₅H₁₀O—)_{y′}—H;
   (d) polydimethylsiloxanediols of the structure
      H-Z-PDMS-Z-H;
   (e) polydimethylsiloxanediamines of the structure
      R′NH—Y—PDMS—Y—HNR′
   (f) polyetherdiamines of the structure
      R′HN—(PO)_{y′}(EO)_{z′}—X-(EO)_{z′}(PO)_{y′}—NHR′,
      in which
      R is an optionally substituted or functionalized hydrocarbon radical having 1 to 50 carbon atoms,
      R′ is an optionally substituted or functionalized hydrocarbon radical having 1 to 8 carbon atoms,
      SO is a divalent radical of styrene oxide,
      BO is a divalent radical of butylene oxide,
      PO is a divalent radical of propylene oxide,
      EO is a divalent radical of ethylene oxide,
      PDMS is a divalent radical of polydimethylsiloxane,
      w is 0 to 5,
      x is 0 to 5,
      y is 0 to 20,
      z is 50 to 200,
      w′ is 0 to 5,
      x′ is 0 to 5,
      y′ is 0 to 10,
      z′ is 1 to 49,
      Z is —CₙH₂ₙO— or —CH₂—CH₂—O—CₙH₂ₙO—,
(D) with n=2 to 12,
   X is —CₙH₂— or —C₆H—,
(E) with n=2 to 12,
   Y is —CₘH₂ₘ,
(F) with m=1 to 8.

Examples of aliphatic triisocyanates are:

Vestanat® 1890-100 (Degussa), Desmodur® N 100 (Bayer); Desmodur® N 3200;

Desmodur® N 3300; Desmodur® N 3600, and Desmodur® 4470 SN.

Examples of aromatic isocyanates are:

Desmodur® IL; Desmodur® L; Suprasec® DNR (Huntsman).

Preference is given to using aliphatic structures, particularly to using hexamethylene diisocyanate (HDI) oligomers, such as Desmodur® N, for example.

These at least trifunctional isocyanates may have their viscosity regulated by the addition of small amounts, 0 to 20 eq-%, of corresponding diisocyanates and/or monoisocyanates.

The isocyanate component (A) is first reacted with 90 to 99.8 eq-% of the monool components (B) of structure RO(SO)_{w}(BO)ₓ(PO)_{y}(EO)_{z}—H by processes that are known per se.

Of substantial significance for the properties of the compounds are the radicals R and also the numerical values of the indices w, x, y, and z.

R is a hydrocarbon radical which optionally is also substituted and has 1 to 50 carbon atoms. Preferred radicals have 12 to 22 carbon atoms, and C₁₈ derivatives are particularly preferred. In the case of shorter hydrocarbon radicals, the alkylene oxide units, styrene oxide (SO) or butylene oxide (BO) function as hydrophobic segments.

The sum of the ethylene oxide radicals (z) is 50 to 200, preferably 100 to 200, more preferably 110 to 150.

The sum of the propylene oxide radicals (y) is 0 to 20, preferably 0 to 10, more preferably 0 to 5.

The sum of the butylene oxide radicals (x) is 0 to 5, preferably 0 to 3, more preferably 0 to 1.

The sum of the styrene oxide radicals (w) is 0 to 5, preferably 0 to 3, more preferably 1.

The skilled worker is well aware that these indices represent average values and all compounds are present in the form of a mixture with a distribution governed essentially by laws of statistics.

Mixtures of different monool components can also be used. These polyethermonools are likewise prepared by prior-art processes, by addition reaction of aromatic and/or aliphatic oxirane compounds with monofunctional alcohols. The addition of the various alkylene oxides may take place blockwise or randomly; a blockwise arrangement is preferred.

At the same time or, preferably, in a second reaction stage, 0.2 to 10.0 eq-% of at least one of the diol or diamine components (C) is supplied to the reaction mixture.

(C)(a): For the polyetherdiols of the structure HO(SO)_{w′}(BO)_{x′}(PO)_{y′}(EO)_{z′}—X-(EO)_{z′}(PO)_{y′}(BO)_{x′}(SO)_{w′}—H, the sum of the ethylene oxide moieties, z′, is 1 to 49, preferably 10 to 40, of the styrene oxide monomers, w′, 0 to 5, preferably 1, of the butylene oxide monomers, x′, 0 to 5, preferably 1, of the propylene oxide monomers, y′, 0 to 10, preferably 3.

These indices as well are again average values; the addition of the various alkylene oxide monomers may take place randomly or, in turn, in blocks. The radical X is the radical —CₙH₂ₙ— or —C₆H₄— of an aromatic, araliphatic or aliphatic diol HO—X—OH, preferably ethylene glycol, propylene glycol, butanediol, cyclohexanedimethanol, dihydroxybenzene or dihydroxydiphenylmethane.

(C)(b): For the polyetherpolydimethylsiloxanediols of structure H(SO)_{w′}(BO)_{x′}(PO)_{y′}(EO)_{z′}-Z-PDMS-Z-(EO)_{z′}(PO)_{y′}(BO)_{x′}(SO)_{w′}—H, the sum of the ethylene oxide moieties, z′, is 0 to 49, preferably 5 to 30, of the styrene oxide monomers, w′, is 0 to 5, preferably 1, of the butylene oxide monomers, x′, is 0 to 5, preferably 1, of the propylene oxide monomers, y′, is 0 to 30, preferably 3 to 15.

The number of dimethylsiloxy units in the chain of the polyethersiloxanediols (C)(b) is 2 to 100, preferably 10 to 60. It is also possible for some or all of the dimethylsiloxy units to be replaced by phenylmethylsiloxy units. The structural unit Z is guided by the nature of the alcohol used for polyether synthesis. Preference is given to using the alcohols allyl alcohol, butenol or hexenol, or else the monovinyl ethers of diols.

(C)(c): The polyesterpolydimethylsiloxanediols of the structure H—(OC₅H₁₀CO- )_{y′}-Z-PDMS-Z-(CO—C₅H₁₀O—)_{y′}, —H can also replace all or some of the polyethersiloxanediols (C)(b).

The choice is guided by the intended application of the thickeners under preparation. The index y′, which represents the number of polyester groups, is 1 to 10, preferably 6. The structural unit Z is guided by the nature of the alcohol used for hydrosilylation. Preference is given to using the alcohols allyl alcohol, butenol or hexenol or else the monovinyl ethers of diols.

(C)(d): In the polydimethylsiloxanediols of the structure H-Z-PDMS-Z-H which can be used additionally, the number of dimethylsiloxy units in the chain is 2 to 100, preferably 10 to 60. It is also possible to replace some or all of the dimethylsiloxy units by phenyl-methylsiloxy units. The structural unit Z is dependent on the nature of the alcohol used for hydrosilylation. Preference is given to using alcohols allyl alcohol, butenol or hexenol or else the monovinyl ethers of diols.

(C)(e): The number of dimethylsiloxy units in the chain of the polydimethylsiloxanediamines of the structure R′NH—Y—PDMS—Y—HNR′ is 2 to 100, preferably 10 to 60.

It is also possible for some or all of the dimethylsiloxy units to be replaced by phenylmethylsiloxy units. When an aminosiloxane is used, the structural unit Y consists of the radical of the unsaturated amine used for hydrosilylation. Particularly preferred amines are allylamine, methallylamine or N-methylallylamine.

(C)(f): Lastly it is possible to use, additionally, polyetherdiamines of the general structure R′NH—(PO)_{y′}(EO)_{z′}—X-(EO)_{z′}(PO)_{y′}—NHR. The value z′, which represents the number of ethylene oxide units, is 1 to 49, preferably 2; the value y′, which represents the number of propylene oxide units, is 0 to 10, preferably 3. The radical X is the radical of an aromatic, araliphatic or aliphatic diol HO—X—OH, preference being given to the use of the diols ethylene glycol, propylene glycol, butanediol, cyclohexanedimethanol, dihydroxybenzene or dihydroxydiphenylmethane.

The stated indices represent average values; the chain-length distribution is guided by the nature of the selected preparation method. This is familiar to the skilled worker and is not part of the patent application.

As polymers in their own right, active polyurethane substances b) cannot be used per se as thickeners, since they are insoluble and so cannot be homogeneously distributed. Conversely, the property of insolubility would be a positive criterion, essential for inks, paints, and varnishes, in order to increase water resistance and abrasion resistance and hence to increase the lifetime of the coating.

Surprisingly it has been found that the polyurethane mixtures of a) and b) according to the invention are miscible with one another in any proportion, and neither additional emulsifiers nor solvents are required. At the same time, they dissolve homogeneously in water over a wide concentration range.

The polyurethanes a) and b) of the invention are jointly melted and the melt is pulverized or granulated by the usual, customary methods.

The invention further provides for the use of the solid polyurethane thickeners to adjust the rheological properties of aqueous systems, such as in aqueous pharmaceutical and cosmetic formulations, crop protection formulations, filler and pigment pastes, laundry detergent formulations, adhesives, waxes, and polishes, and also for petroleum extraction, but preferably in paints and coatings.

In addition, it is noted that the solid active polyurethane substances, consisting of substances of type a) and substances of type b), can of course also be combined with emulsifiers and/or solvents. In this way as well it is possible to reduce the fraction of water-soluble compounds within the applied coating, and to enhance the technical coatings properties.

The example compounds are prepared by processes which are known per se.

### EXAMPLE 1

A water-soluble active polyurethane thickener substance (a) was prepared as follows:

180 g of a polyethylene glycol having a molecular weight of 6000 (0.03 mol) was charged under N₂ to the dry reactor.

For the dewatering of the polyether, the product was heated in the reaction vessel to 110° C. and was dewatered under vacuum (less than 15 mm) under a gentle stream of nitrogen for 1 h; the water content (according to Karl Fischer) should be less than 0.03%. In the case of a higher water content, the dewatering time was extended accordingly. After drying, the batch was cooled to 80° C.

Then, 4.66 g of Vestanat® IPDI (isophorone diisocyanate), having an NCO index of 1.05, and 5.9 g of stearyl isocyanate were added to the liquid reaction mixture. First of all the isocyanates were intimately mixed with the OH-functional components.

Then, 4 g of dibutyltin dilaurate were added; in the course of this addition a slight exothermic reaction was apparent, with an increase in temperature of approximately 10° C. The reaction mixture was still very fluid.

After 6 hours, the reaction was monitored by a determination of the NCO content. At an NCO value of less than 0.01%, the reaction was very close to complete.

A waxlike substance was obtained which at room temperature was pale yellow and very fragile.

### EXAMPLE 2

A water-insoluble active polyurethane thickener substance (b) was prepared as follows:

93 eq-% of a polyether prepared starting from stearyl alcohol, alkoxylated with 100 mol of EO (MW according to OHN: 4500 g/mol), 4 eq-% of a polyether prepared starting from propylene glycol, alkoxylated with 5 mol of EO and 3 mol of SO (MW according to OHN: 610 g/mol), and 3 eq-% of the polysiloxanediol “Tegomer® HSi-2111”, with a molecular weight of 810 g/mol, were charged under N₂ to a dry reactor.

For the dewatering of the mixture, the products were heated in the reaction vessel to 110° C. and were dewatered under vacuum (less than 15 mm) under a gentle stream of nitrogen, until the water content (according to Karl Fischer) was less than 0.03%. After drying, the batch was cooled to 80° C.

Then, 600 g of Desmodur® N, corresponding to 1.05 mol, having an NCO index of 1.05 were added to the liquid reaction mixture.

First, of all the Desmodur® N was intimately mixed with the OH-functional components.

Then, 5 g of dibutyltin dilaurate were added; in the course of this addition a slight exothermic reaction was apparent, with an increase in temperature of approximately 10° C. The viscosity increased markedly over time.

After 6 hours, the reaction was monitored by a determination of the NCO content. At an NCO value of less than 0.01% the reaction was very close to complete.

A waxlike substance was obtained which at room temperature was pale yellow and very fragile.

### EXAMPLE 3

For the active PU substances manufactured according to examples 1 and 2 the solubility in water was measured:

Solubility of product a), example 1, in water at 20° C.: infinite

Solubility of product b), example 2, in water at 20° C.: less than 3 g/l.

### EXAMPLE 4

The melting points were measured for the active PU substance manufactured according to example 1, and also the active PU substance manufactured according to example 2, and blends of these substances. (Kofler melting point determination)
4.1. 100% product of example 1, 57° C.
4.2. 75% product of example 1+25% product of example 2, 47° C.
4.3. 50% product of example 1+50% product of example 2, 48° C.
4.4. 25% product of example 1+75% product of example 2, 49° C.
4.5. 100% product of example 2, 50° C.

### EXAMPLE 5

Aqueous solutions were prepared from the products of examples 4.1. (corresponding to example 1), 4.2., 4.3., 4.4., and 4.5.

For that purpose the products of the invention were ground in a laboratory mill to a particle size of 0.2 to 1 mm and introduced into water with stirring using a dissolver at 1500 rpm.

The products were dissolved within 10 minutes.

After a storage time of 24 hours at room temperature, the viscosities as measured using the Haake viscotester L7 at 10 rpm were as reported in table 1:

TABLE 1

| | Product of | Concentration in | Viscosity [m Pas] |
|---|---|---|---|
| Experiment | example | water (%) | (1 rpm) |
| 5.1. | 4.1. | 6 | 19 800 |
| 5.2. | 4.2. | 6 | 41 000 |
| 5.3. | 4.3. | 6 | 44 500 |
| 5.4. | 4.4. | 6 | 19 500 |
| 5.5. | 4.5. | 6 | inhomogeneous, |
| | | | insoluble |
| 5.6. | 4.1. | 3 | 8900 |
| 5.7. | 4.2. | 3 | 7800 |
| 5.8. | 4.3. | 3 | 6150 |
| 5.9. | 4.4. | 3 | inhomogeneous, |
| | | | insoluble |
| 5.10. | 4.5. | 3 | inhomogeneous, |
| | | | insoluble |

### EXAMPLE 6

The PU products of example 5.6.; 5.7.; 5.8.; and 5.9., in solution in water, were introduced into an acrylate dispersion¹⁾ whose composition was as follows:

The following constituents, in accordance with table 2, were prepared to 100 g in a 200 ml stirred vessel. For that purpose the products prepared according to example 5 were mixed homogeneously with the acrylate dispersion. After 24 hours, the resulting viscosity was measured using the Haake L7 viscometer.

TABLE 2

| | | | PU amount (absolute, | | |
|---|---|---|---|---|---|
| | | Composition of acrylate | based on dispersion | Viscosity [mPas] | |
| Experiment | PU composition | dispersion | in as-supplied form) | 1 rpm | 10 rpm |
| 8.0. | -none- | 100% Dilexo RA3 | 0 | | |
| 8.1. | 4.1. | 99% Dilexo RA3 + 1% 5.6. | 0.0003 | 58 710 | 20 570 |
| 8.2. | 4.2. | 99% Dilexo RA3 + 1% 5.7. | 0.0003 | 67 510 | 25 060 |
| 8.3. | 4.3. | 99% Dilexo RA3 + 1% 5.8. | 0.0003 | 84 550 | 33 180 |
| 8.4. | 4.1. | 98% Dilexo RA3 + 2% 5.6. | 0.0006 | 86 480 | 29 320 |
| 8.5. | 4.2. | 98% Dilexo RA3 + 2% 5.7. | 0.0006 | 151 090 | 40 460 |
| 8.6. | 4.3. | 98% Dilexo RA3 + 2% 5.8. | 0.0006 | 189 630 | 55 650 |

1) Dilexo RA3 ® is a dispersion based on a pure acrylate from Neste Chemicals GmbH, Kunstharze Meerbeck, Roemer Straβe 733, D-47443 Moers, Germany.

### EXAMPLE 7

The PU solid of example 4.3 and also the PU product of example 5.6. in aqueous solution were tested for effectiveness in a dispersion-based coating material having the composition indicated in table 3.

TABLE 3

| Product | | 7.1. [g] | 7.2. [g] | 7.3. [g] | 7.4. [g] | 7.5. [g] |
|---|---|---|---|---|---|---|
| AMP (aminopro- | (1) | 2.50 | 2.50 | 2.50 | 2.50 | 2.50 |
| panol)¹⁾ | | | | | | |
| Tego PE 4648²⁾ | (2) | 5.50 | 5.50 | 5.50 | 5.50 | 5.50 |
| Tego Foamex | (3) | 1.00 | 1.00 | 1.00 | 1.00 | 1.00 |
| 855³⁾ | | | | | | |
| Thickener as | (4) | 10.00 | 5.00 | 2.50 | 1.25 | |
| per 4.3. | | | | | | |
| Thickener as | (4) | | | | | 41.70 |
| per 5.3. | | | | | | |
| TiO₂-RHD-2⁴⁾ | (5) | 225.00 | 225.00 | 225.00 | 225.00 | 225.00 |
| Methoxybutanol | (6) | 17.00 | 17.00 | 17.00 | 17.00 | 17.00 |
| Propylene glycol | (7) | 17.00 | 17.00 | 17.00 | 17.00 | 17.00 |
| Butyl diglycol | (8) | 17.00 | 17.00 | 17.00 | 17.00 | 17.00 |
| Water | (9) | 49.00 | 44.00 | 39.00 | 35.00 | |
| Water | (10) | 116.00 | 126.00 | 133.50 | 138.75 | 132.30 |
| Neocryl XK 61 | (11) | 540.00 | 540.00 | 540.00 | 540.00 | 540.00 |
| (42%)⁵⁾ | | | | | | |
| Total | | 1000.00 | 1000.00 | 1000.00 | 1000.00 | 1000.00 |

¹⁾(2-Amino-2-methylpropan-1-ol, 90% strength in water), Angus Chemie GmbH, Essen
²⁾Wetting agent, Tego Chemie Service, Essen
³⁾Defoamer, Tego Chemie Service, Essen
⁴⁾Pigment, Tioxide
⁵⁾Acrylate dispersion, ICI-Resin, Waalwijk

Products 1 to 9 were dispersed in a dissolver at 1500 rpm with 200 g of glass beads (Ø3 mm) for 30 minutes. This was followed by the rapid and continuous addition of components 10 and 11. The formulation was homogenized for 3 minutes additionally in each case.

After 24 hours, the resulting viscosity was measured using the Haake L7 viscometer. The result is given in table 4:

TABLE 4

| rpm | 7.1 | 7.2 | 7.3 | 7.4 | 7.5 |
|---|---|---|---|---|---|
| 5 | 43 750 | 28 350 | 18 650 | 1450 | 18 650 |
| 10 | 36 450 | 24 900 | 17 050 | 1230 | 17 050 |
| 20 | 32 380 | 22 250 | 15 900 | 1215 | 15 900 |

A typical utilization viscosity was situated within an order of magnitude of approximately 5000 mPas at 10 rpm, and hence ranged from an addition of 0.125% up to 0.25% of active PU substance.

The required added amount of known active PU substances was higher by a factor of 4 to 8.

### EXAMPLE 8

The PU solid of example 4.3 was tested for its effectiveness in a dispersion-based coating material with the composition given in table 5.

The following constituents were introduced together in a 1000 ml stirred vessel:

Products 1 to 11 were dispersed in a dissolver at 1500 rpm for 30 minutes. This was followed by the rapid and continuous addition of components 12 to 14. Subsequently the coating material was homogenized for a further 5 minutes.

TABLE 5

| Raw materials | | 8.1. [g] | 8.2. [g] | 8.3. [g] | 8.4. [g] |
|---|---|---|---|---|---|
| 1,2-Propylene glycol | (1) | 20.00 | 20.00 | 20.00 | 20.00 |
| Butyl diglycol | (2) | 20.00 | 20.00 | 20.00 | 20.00 |
| Methoxybutanol | (3) | 20.00 | 20.00 | 20.00 | 20.00 |
| Water | (4) | 115.00 | 115.00 | 115.00 | 115.00 |
| Thickener as per 4.3 | (5) | 2.00 | — | — | — |
| Coatex BR 910 G¹⁾ | (5) | — | 2.00 | — | — |
| Rheolate 205²⁾ | (5) | — | — | 2.00 | — |
| Rheolate 208³⁾ | (5) | — | — | — | 2.00 |
| Tego ® Dispers 715 W⁴⁾ | (6) | 6.00 | 6.00 | 6.00 | 6.00 |
| Tego ® Wet 500⁴⁾ | (7) | 4.00 | 4.00 | 4.00 | 4.00 |
| Acticide RS | (8) | 3.00 | 3.00 | 3.00 | 3.00 |
| Aqueous sodium hydroxide | (9) | 2.00 | 2.00 | 2.00 | 2.00 |
| solution (15% strength) | | | | | |
| Tego ® Foamex 8030⁴⁾ | (10) | 3.00 | 3.00 | 3.00 | 3.00 |
| Kronos 2190 | (11) | 220.00 | 220.00 | 220.00 | 220.00 |
| Dilexo RA 3 | (12) | 552.00 | 552.00 | 552.00 | 552.00 |
| Tego ® Foamex 8030⁴⁾ | (13) | 3.00 | 3.00 | 3.00 | 3.00 |
| Südranol 230⁵⁾ | (14) | 30.00 | 30.00 | 30.00 | 30.00 |
| Total | | 1000.00 | 1000.00 | 1000.00 | 1000.00 |

¹⁾Coatex BR 910 G (Dimed/Coatex, Cologne)
²⁾Rheolate 205 (Elementis, Leverkusen)
³⁾Rheolate 208 (Elementis, Leverkusen)
⁴⁾Tego Dispers, Wet, Foamex (Tego Chemie Service GmbH, Essen)
⁵⁾Südranol 230 (Süddeutsche Emulsions Chemie, Mannheim)

After a maturation time of approximately 24 hours it was possible to carry out the performance tests. For that purpose, the viscosity of the samples was determined by means of a Haake rheometer (RS 1).

TABLE 6

Viscosity

| | 8.1 | 8.2 | 8.3 | 8.4 |
|---|---|---|---|---|
| D = 10.3 s⁻¹ | 2220 | | 1200 | 1180 |
| D = 100 s⁻¹ | 1290 | | 680 | 630 |
| D = 600 s⁻¹ | 595 | | 420 | 403 |

While the present invention has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated, but fall within the scope of the appended claims.

What is claimed is:

1. A pulverulent thickener preparation comprising
a) at least one water-soluble active polyurethane thickener substance; and
b) at least one water-insoluble or sparingly water-soluble active polyurethane thickener substance.

2. The pulverulent thickener preparation as claimed in claim 1, containing 80% to 10% by weight of a) and 20% to 90% by weight of b).

3. The pulverulent thickener preparation as claimed in claim 1, wherein the water solubility of the active polyurethane thickener substances a) is greater than 10 g/l.

4. The pulverulent thickener preparation as claimed in claim 1, wherein the active polyurethane thickener substances a) contain hydrophilic segments in an amount of at least 50% by weight.

5. The pulverulent thickener preparation as claimed in claim 1, wherein the active polyurethane thickener substances a) contain high molecular mass polyether chains as hydrophilic segments.

6. The pulverulent thickener preparation as claimed in claim 1, wherein the water solubility of the active polyurethane thickener substances b) is less than 10 g/l.

7. The pulverulent thickener preparation as claimed claim 1, wherein the active polyurethane thickener substances b) contain hydrocarbon chains having at least 6 carbon atoms as hydrophobic segments.

8. The pulverulent thickener preparation as claimed in claim 1, wherein use is made as active polyurethane thickener substances b) of compounds which are preparable from
(A) at least trifunctional aliphatic and/or aromatic isocyanate oligomers with
(B) 90.0 to 99.8 eq-% of one or more polyethers of the structure RO(SO)_{w}(BO)ₓ(PO)_{y}(EO)_{z}—H, and
(C) 0.2 to 10.0 eq-% of at least one of the compounds selected from the group of
(a) polyethers of structure
HO(SO)_{w′}(BO)_{x′}(PO)_{y′}(EO)_{z′}—H
(b) polyetherpolydimethylsiloxanediols of structure
HO(SO)_{w′}(BO)_{x′}(PO)_{y′}(EO)_{z′}-Z-PDMS-Z(EO)_{z′}(PO)_{y′}(BO)_{x′}(SO)_{w′}—H
(c) polyesterpolydimethylsiloxanediols of structure
H—(OC₅H₁₀CO-)_{y′}-Z-PDMS-Z-(CO—C₅H₁₀O—)_{y′}—H
(d) polydimethylsiloxanediols of structure
H-Z-PDMS-Z-H
(e) polydimethylsiloxanediamines of structure
R′NH—Y—PDMS—Y—HNR′
(f) polyetherdiamines of structure
R′HN—(PO)_{y′}(EO)_{z′}—X-(EO)_{z′}(PO)_{y′}—NHR′
in which
R is an optionally substituted or functionalized hydrocarbon radical having 1 to 50 carbon atoms,
R′ is an optionally substituted or functionalized hydrocarbon radical having 1 to 8 carbon atoms,
SO is a divalent radical of styrene oxide,
BO is a divalent radical of butylene oxide,
PO is a divalent radical of propylene oxide,
EO is a divalent radical of ethylene oxide,
PDMS is a divalent radical of polydimethylsiloxane,
w is 0 to 5,
x is 0 to 5,
y is 0 to 20,
z is 50 to 200,
w′ is 0 to 5,
x′ is 0 to 5,
y′ is 0 to 10,
z′ is 1 to 49,
Z is —CₙH₂ₙO— or —CH₂—CH₂—O—CₙH₂ₙO—,
with n=2 to 12,
X is —CₙH₂ₙ— or —C₆H₄—,
with n=2 to 12,
Y is —CₘH₂ₘ,
with m=1 to 8.

9. A method comprising adding the pulverulent thickener preparation as claimed in claim 1 as a rheological additive to an aqueous system.

10. A method comprising adding the pulverulent thickener preparation as claimed in claim 1 into at least one of aqueous ink, a paint, and a varnishe.
